(19) United States
(12) Patent Application Publication
(10) Pub. No.: US 2024/0095295 A1
(43) Pub. Date: Mar. 21, 2024

(54) Method of Automatically Navigating to a Digital Destination Via a Registered Target

(71) Applicant: Darrin L. Pennington, Denton, TX (US)

(72) Inventor: Darrin L. Pennington, Denton, TX (US)

(21) Appl. No.: 18/118,099

(22) Filed: Mar. 6, 2023

Related U.S. Application Data
(60) Provisional application No. 63/408,830, filed on Sep. 21, 2022.
(60) Provisional application No. 63/436,298, filed on Dec. 30, 2022.

(51) Int. Cl. G06F 16/954; G06F 40/205; G06V 30/10

(52) U.S. Cl. CPC G06F 16/954; G06F 40/205; G06V 30/10; G06V 2201/09

(57) ABSTRACT

This disclosure describes a method that quickly and automatically connect a user's computing device to a digital destination. The method includes receiving an image from the user's computing device, automatically searching, in a database including a plurality of entries each having a target and an associated digital destination address, where automatically searching includes processing the image, determining whether the image contains one of the targets in the plurality of entries, and returning the associated digital destination address in response to a determination that the image contains one of the targets in the plurality of entries. The returned digital destination address automatically enables the user's computing device to connect with the returned associated destination address.

### RELATED APPLICATION

This patent application claims the benefit of U.S. Provisional Patent Application No. 63/408,830 filed on Sep. 21, 2022, and U.S. Provisional Patent Application No. 63/436,298 filed on Dec. 30, 2022, both of which are incorporated herein by reference.

### FIELD

The present disclosure relates generally to a method of automatically navigating to a digital destination via a registered target.

### BACKGROUND

Augmented Reality and text scanning have become very popular recently. Both technologies have been used for video games, studying, looking up something on the internet, etc. People have come up with some really interesting ways to connect the real world with the virtual world and are still coming up with new ways daily. Though it is well known that pretty much any smartphone these days can take a piece of text, scan it with the camera, and look it up on the internet, this still comes with the risk of users looking up a piece of text and getting thousands of options or businesses that they weren't even looking for. This is not beneficial for the user but also not beneficial for businesses. If someone looks up a business name using conventional text scanning and look-up technology, they still run the risk of the user having a competitor catch their attention.

### BRIEF DESCRIPTION OF THE DRAWINGS

FIG. 1 is a simplified flowchart of an exemplary embodiment of a method of automatically navigating to a digital destination via a registered target according to the teachings of the present disclosure;

FIG. 2 is a simplified block diagram of an exemplary embodiment of a method of automatically navigating to a digital destination via a registered target according to the teachings of the present disclosure;

FIG. 3 is a simplified block diagram of an exemplary embodiment of a method of automatically navigating to a digital destination via a registered target according to the teachings of the present disclosure;

FIG. 4 is a simplified flowchart of an exemplary embodiment of a registration process for a method of automatically navigating to a digital destination via a registered target according to the teachings of the present disclosure;

FIG. 5 is an illustration of an exemplary embodiment of a Quick Link database entry for a method of automatically navigating to a digital destination via a registered target according to the teachings of the present disclosure;

FIG. 6 is a more detailed flowchart of an exemplary embodiment of a method of automatically navigating to a digital destination via a registered target according to the teachings of the present disclosure; and

FIG. 7 is a simplified illustration of an exemplary embodiment of Quick Link database items for a method of automatically navigating to a digital destination via a registered target according to the teachings of the present disclosure.

### DETAILED DESCRIPTION

The inventive concept described herein enables a smartphone camera to take an image of text, logo, graphic, or 3-dimensional object and enable the device to automatically proceed directly to a digital address such as a URL (Uniform Resource Locator) of a website, a social media profile, a multimedia channel, a podcast, a playlist, or another digital destination associated with the scanned image by referring to a registration database. The digital destination can exist anywhere, such as in the world wide web, on a social media platform, a multimedia platform, a metaverse, etc. A nickname given to this capability that is used herein to refer to this technology is “Quick Link.” The Quick Link application preferably executes on mobile devices such as smartphones, but may operate on any computing device that has an image capturing function capable of capturing still images and/or video images as well as the capability to connect to the Internet via any suitable communication channel, such as WiFi, LAN, WAN, and cellular networks.

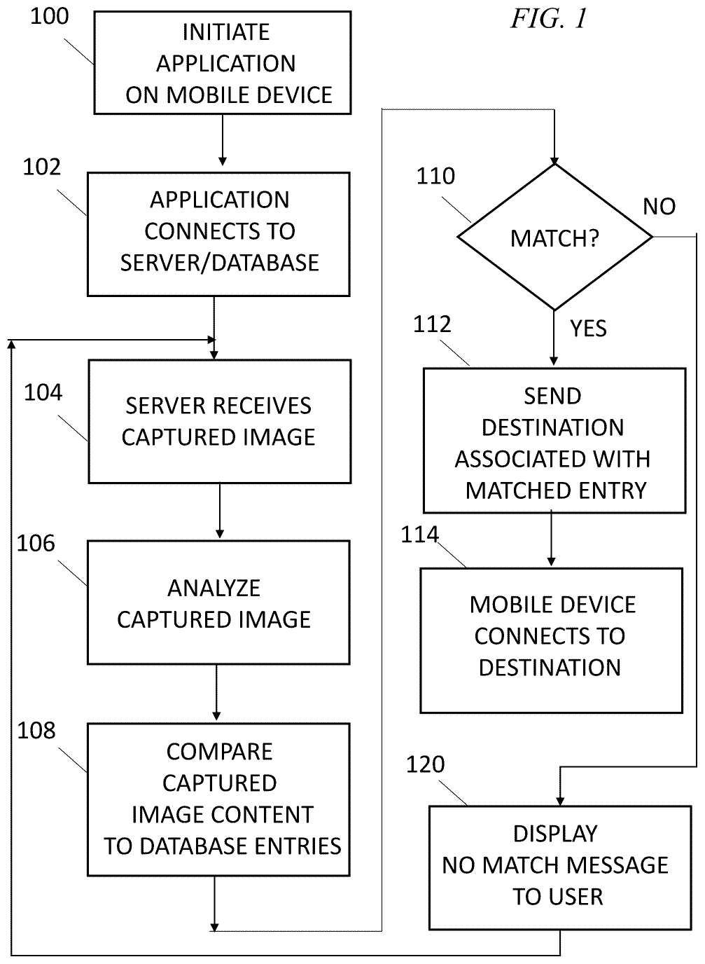

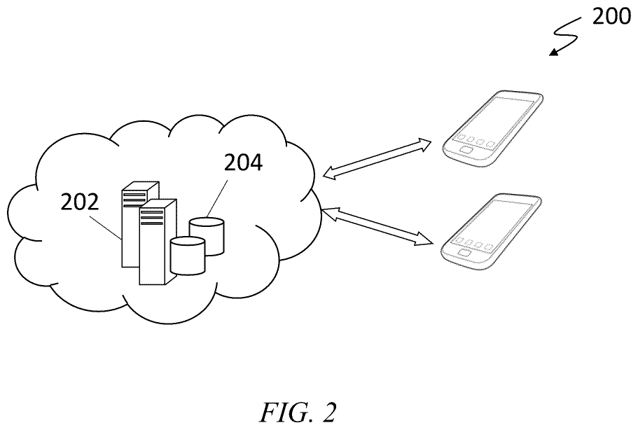

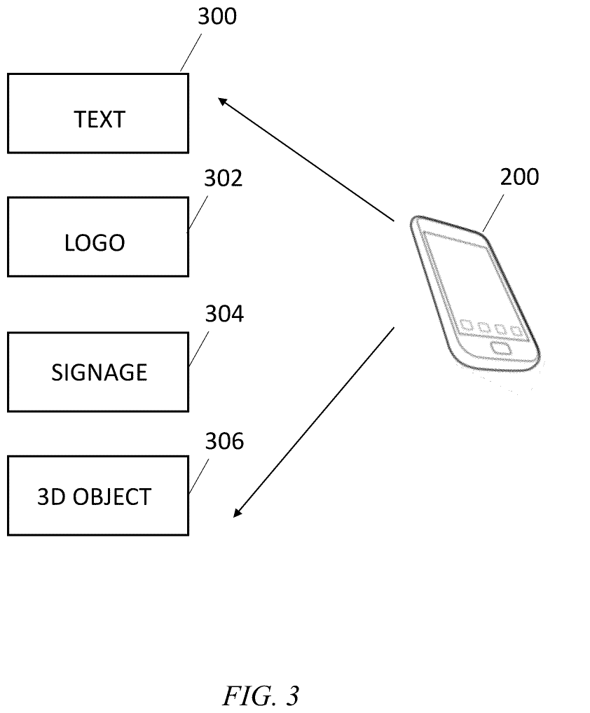

FIG. 1 is a simplified flowchart of an exemplary embodiment of a method of automatically navigating to a digital destination via a registered target according to the teachings of the present disclosure. Referring also to FIG. 2, users may download a Quick Link mobile app onto their mobile devices 200 from the play store or a dedicated Quick Link website hosted in one or more cloud servers 202 and databases 204. Alternatively, the Quick Link function may be native to the users' mobile devices 200. The user initiates operation of the Quick Link mobile app on the mobile device, as shown in block 100. Upon start up, the Quick Link application connects to a remote server and database (which may be the same server 202 and database 204), as shown in block 102. As shown in FIG. 3, the user uses the camera on the mobile device 200 to scan and capture images of text (e.g., trademark and slogan) 300, graphics (e.g., logo) 302, signage 304, or 3-dimensional (3-D) objects 306, and the Quick Link application transmits the captured images to the remote server, as shown in block 104. Preferably, the user merely points the camera at the target and the resulting images are used for the Quick Link function. In this way, the user is not required to take a picture of the target but instead can use the camera to scan their environment in an active and fluid way to determine in real-time if any target is associated with a Quick Link. The captured images are analyzed to determine whether they contain target text, logo, graphics, or 3D objects stored in the Quick Link database, as shown in block 106. The analysis includes comparing the content of the captured images to target text, logo, graphics, and 3D objects stored in the database, as shown in block 108. If there is a match, as determined in block 110, then the digital destination associated with the matched entry is read from the database and transmitted to the mobile device, as shown in block 112. The mobile device then automatically links and connects to the digital destination, as shown in block 114. Such digital destination may be a URL to a website, a social media profile (e.g., Facebook, LinkedIn, Instagram, Twitter), a media channel (e.g., Youtube), an address on a digital map (e.g., Google Maps), a stored resource such as a document, etc. If a match is not found in the database (search result is nil), then an appropriate message is displayed on the screen of the mobile device to inform that the image did not contain a target, as shown in block 120. The user may use the mobile device to continue to scan and capture images that will be analyzed by the Quick Link application.

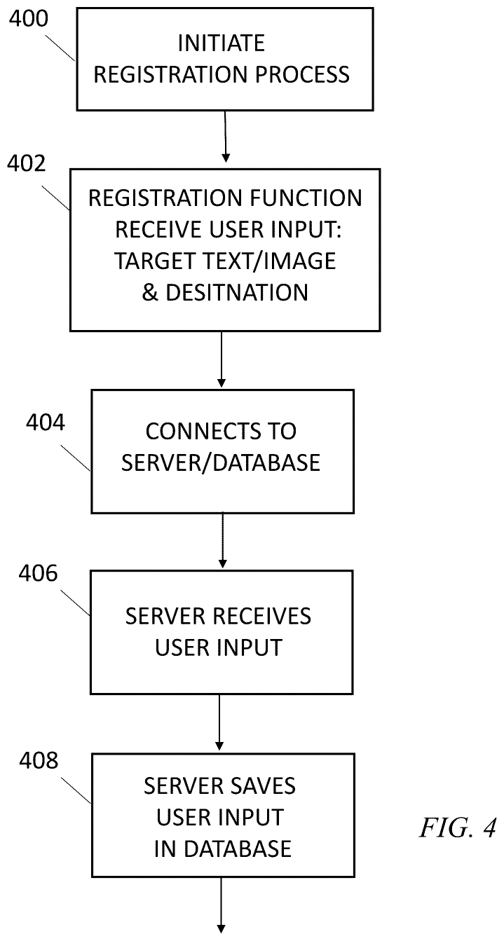

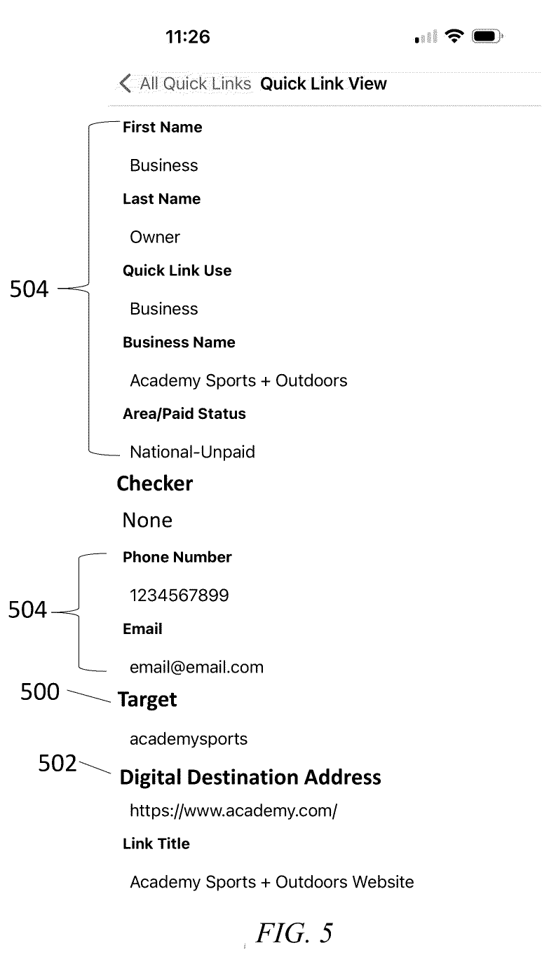

FIG. 4 is a simplified flowchart of an embodiment of a target registration process according to the teachings of the present disclosure. This process may be performed by an administrator or a user having a Quick Link account that enable the user to register a certain number of Quick Link targets. In block 400, a registration application is initiated. Alternatively, the registration function is accessible via the Quick Link application or the Quick Link website. Using an input screen or form such as the one shown in FIG. 5, the user may enter and upload information to enable Quick Link functionality associated with their specific target. In the example shown in FIG. 5, the “Target” field 500 is used to specify the target text, logo, signage, or 3D object that will be stored in the database and searched for a match. For the example in FIG. 5, the target is a text string “academysports”. For targets that are logos, signage, and 3-dimensional objects, multiple image files of the target should be provided to enable a match when users' images depict different perspectives, angles, and lighting. The “Digital Destination Address” field 502 is used to specify the address or URL of the digital destination or asset that will be provided and connected to upon a target match. The owner of this Quick Link entry may further input their name, contact information, and account status 504. This registration process enables sponsors and business owners to register their text strings (trademarks and slogans), graphics (logos), signages, and 3D objects (e.g., goods) to enable users to quickly and automatically link to their digital destinations or digital assets using the Quick Link application/functionality. It should be noted that entries in the Quick Link database may be edited by the administrator and users with editorial access to the database.

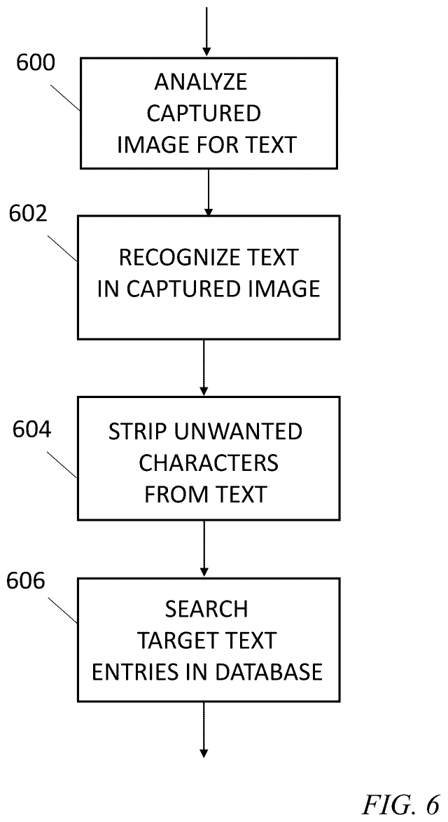

FIG. 6 is a simplified flowchart of an embodiment of a target capturing process according to the teachings of the present disclosure. In block 600, the image captured by the camera of the mobile device is analyzed for its content. In this example, the image is analyzed to determine if it contains alphanumeric text using a method such as optical character recognition (OCR) or another suitable technology, as shown in block 602. If text is recognized, unwanted characters and styles such as spaces, symbols, punctuation, capitalization, and new line, are removed to produce a search text string, as shown in block 604. The target fields of the entries in the Quick Link database are then searched to determine whether the search text string is contained in any one of the entries, as shown in block 606.

As an example, if a user scans a phrase “I'm the coolest guy ever . . . well at least since 6 B.C.” The Quick Link application would recognize that the image contains text and strip it down to “imthecoolestguyeverwellatleastsince6bc”. This is the search text string. It then searches the entries in the Quick Link database to look for a match with the search text string. The search looks at each Quick Link entry to see if its target text is the same or is contained in the search text string. For example, the database may contain an entry with the target field having the text string “coolestguyever”. Because the scanned text contains the text string “coolestguyever” it would prompt the mobile device to automatically navigate to an URL associated with the matched target string, which is a FACEBOOK profile at www.facebook.com/darrinpennington. Alternately, the Quick Link application may display a button that says “Cool Guy's Facebook” to enable the user to click on it to navigate to the FACEBOOK profile.

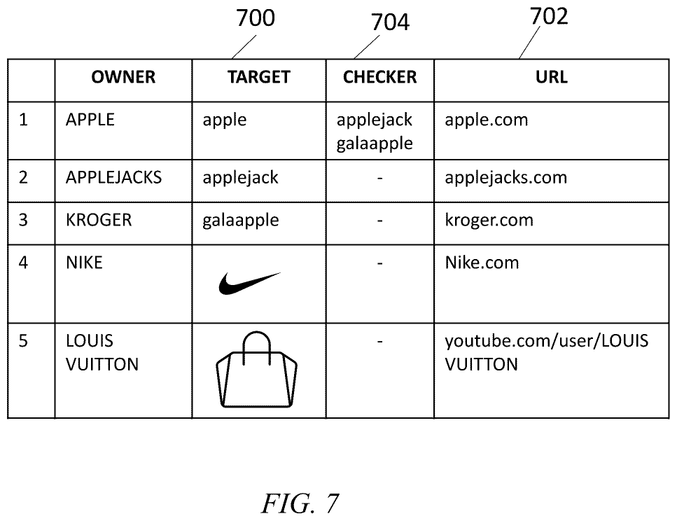

Special accommodations may be needed to resolve potential conflicts involving Quick Link text strings that have overlap. As shown in FIG. 7, for example, APPLE, the electronic device maker, may occupy a Quick Link entry having the target text 700 of “apple” that leads to the digital destination URL 702 of “apple.com”. Another Quick Link entry in the database may specify “applejack” as the target text 700 with the associated digital destination address (e.g., URL) 702 as “applejacks.com”. A third database entry specifies “galaapple” as the target, and the associated URL as “kroger.com”. If an image scanned by a user contains the text string “Apple” then the Quick Link application will automatically check the Checker field 704 associated with the “apple” entry, which contains two entries: “applejack” and “galaapple”. The Quick Link application then automatically checks the scanned search text string to determine if it contains any of the text strings in the Checker field 704. If the search text string contains either “applejack” or “galaapple” then the search rejects the “apple” entry and continues down the database. The Checker field 704 is thus used to specify those items (text or other types of elements) that should be excluded (an excluded target), so that if the image contains what is specified in the Checker field of an entry, then the digital destination address of that entry should not be returned even if there is a match.

When the target field is non-text and instead contains a graphic or pictorial design (e.g., logo, painting) and a 3D object (e.g., a shoe, a bag, an outfit, a sign, a store façade, a building), the Quick Link application compares the captured image to the stored target images in the database to determine a match. Artificial intelligence, machine learning, Google Lens, and other techniques and applications may be used to search for and compare image contents. For example, if NIKE, the athletic wear company, wants Quick Link users to be able to scan an actual NIKE athletic shoe on someone's foot, to be able to automatically navigate to the NIKE website page selling that exact model of shoe, NIKE may upload images of multiple views (e.g., side, front, back, top, bottom, perspective views) of each shoe in its inventory as the target images in the Quick Link database. Preferably with the aide of techniques such as artificial intelligence, machine learning, and Google Lens, the Quick Link application is able to correctly identify a match a user's snapshot to a target entry in the Quick Link database even when the stored target images don't match up with the user's scanned image precisely by taking account of different angles, lighting, sizes, etc.

Below are example use cases for the Quick Link application and functionality.

The State Farm insurance company may register its business name or trademark (“State Farm”) so that every time a user scans their business name (“State Farm”), the user's device would automatically navigate to a webpage where they can get a quote for insuring their home, car, or business, or to their latest promotional video on their Youtube channel. The user may scan a “State Farm” signage on a building, scan the words “State Farm” on an advertisement on the court at a professional game, scan the words “State Farm” on a pen, scan “State Farm” handwritten on a piece of paper, and scan “State Farm” displayed on a TV screen. By registering the words “State Farm”, these words become an active Quick Link.

Denton Beauty House is a salon in Denton, Texas. By registering its business name, “Denton Beauty House”, anytime anyone scans the words “Denton Beauty House” on a sign, bumper sticker, a T-shirt, etc., the user's mobile device automatically navigates to the Instagram profile for the business.

Athletic wear maker, Nike, may register its trademarks such as NIKE, JUST DO IT, its swoosh logo design, and a shoe in the Quick Link database, so that anytime someone scans one of these registered targets, the user is automatically taken to a digital destination, such as its website, an online storefront where their merchandise is sold, an address location of its local retail store marked on a digital map, its current advertising campaign video, etc.

Luxury goods maker, Louis Vuitton, may register its trademarks as well as images of their goods (e.g., handbags, wallets, and shoes) in the Quick Link database. A user may scan a registered trademark or take a picture of one of their registered handbags, and their device automatically navigates to a digital destination specified in the Quick Link database, such as its website, an online storefront where their merchandise is offered, its storefront in the metaverse, a video of its newest runway show, etc.

School districts may register their school district name so that anytime someone scans the school district name written or displayed in style, font, and color, the user's devices is automatically instructed to navigate to the district's announcement web page. For example, Farmersville ISD may register “Farmersville ISD” so that every time someone scans the phrase “Farmersville ISD”, the user's device automatically navigates to the Farmersville ISD announcement web page that provides information on school closings, special events, sporting events, etc.

School teachers have had problems in the past with having their students navigate to online instruction modules. With Quick Link, a teacher named “Mr. Clark”, may register a phrase “Mr. Clark is awesome” in the Quick Link database so that when a student scans this phrase, the student's device will navigate to the correct online course. The students may scan the target phrase “Mr. Clark is awesome” written on the board by the teacher to enable his students' devices to quickly and automatically navigate to the correct instruction module.

A Venmo user may register a phrase such as “Best lawnmower ever” with the Quick Link database so that anyone who scans this phrase, their device would automatically navigate to the user's Venmo account for making a payment.

A user takes a picture of the Washington Monument, and the Quick Link application on the user's device automatically searches the Quick Link database to determine whether an entry exists that matches the image. The Quick Link database may contain an entry that contains one or more images of the Washington Monument as the target that would enable a match to be recognized regardless of the composition and lighting depicted in the user's picture. Upon matching the correct target entry, the user's device automatically connects to a virtual tour of the Washington Monument with narration of its history.

The features of the present invention which are believed to be novel are set forth below with particularity in the appended claims. However, modifications, variations, and changes to the exemplary embodiments of the inventive concepts described above will be apparent to those skilled in the art, and the described herein thus encompasses such modifications, variations, and changes and are not limited to the specific embodiments described herein.

What is claimed is:

1. A method of quickly and automatically connecting a user's computing device to a digital destination, the method comprising:
receiving an image from the user's computing device;
automatically searching, in a database including a plurality of entries each having a text string target and an associated digital destination address, wherein automatically searching comprises:
processing the image;
determining whether the image contains one of the text string targets in the plurality of entries; and
providing the associated digital destination address in response to a determination that the image contains one of the text string targets in the plurality of entries; and
automatically enabling the user's computing device to connect with the digital destination specified by the associated digital destination address.

2. The method of claim 1, further comprising automatically displaying a message on the computer device in response to a determination that the image does not contain any text string target in the plurality of entries in the database.

3. The method of claim 1, wherein processing the image comprises:
recognizing that the image contains a text string including alphanumeric characters;
removing blank spaces, symbols, and punctuation marks from the text string; and
generating a search text string used to search the plurality of entries in the database.

4. The method of claim 3, further comprising:
upon determining that the image contains one of the text string targets in the database, determining whether the image also contains an excluded text string target; and
providing the associated digital destination address only in response to a determination that the excluded text string target is absent in the image.

5. The method of claim 1, wherein providing the associated digital destination address comprises returning an address pointing to a digital destination selected from the group consisting of a web page, a social media profile, a multimedia channel, a podcast, a playlist, and a metaverse location.

6. The method of claim 1, further comprising:
receiving a registration entry comprising:
the target selected from the group consisting of a text string, a trademark, at least one image file depicting a logo, at least one image file depicting a design, and at least one image file depicting a 3-dimensional object; and
at least one associated digital destination address; and
saving the registration entry in the database.

7. The method of claim 6, wherein automatically searching, in a database comprises searching a plurality of entries each having one of a text string, trademark, logo, design, 3-dimensional target, and providing the associated digital destination address in response to a determination that the image contains one of the text string, trademark, logo, design, 3-dimensional targets in one of the plurality of database entries.

8. A method of quickly and automatically linking a user's computing device to a digital destination, the method comprising:
receiving a plurality of images from the user's computing device;
automatically searching, in a database including a plurality of entries having a plurality of targets each with an associated digital destination address, wherein automatically searching comprises:
processing the plurality of images;
determining whether at least one of the plurality of images contain any of the plurality of targets in the database; and
returning the digital destination address associated with the target that is present in the at least one of the plurality of images; and
automatically enabling the user's computing device to connect with the digital destination specified by the returned associated digital destination address.

9. The method of claim 8, further comprising automatically displaying a message on the computer device in response to a determination that the plurality of images do not contain the target in the at least one entry.

10. The method of claim 8, wherein receiving a plurality of images from the user's computing device comprises receiving a plurality of images of a subject selected from the group consisting of a text string, a trademark, a logo, a design, and a 3-dimensional object.

11. The method of claim 10, wherein processing the plurality of images comprises:
recognizing that the plurality of images contain a text string including alphanumeric characters;
removing blank spaces, symbols, and punctuation marks from the text string; and
generating a search text string used to search the plurality of entries in the database.

12. The method of claim 8, wherein returning the associated digital destination address comprises returning an address pointing to a digital destination selected from the group consisting of a web page, a social media profile, a multimedia channel, a podcast, a playlist, and a metaverse location.

13. The method of claim 8, further comprising:
receiving a registration entry comprising:
the target selected from the group consisting of a text string, a trademark, at least one image file depicting a logo, at least one image file depicting a design, and at least one image file depicting a 3-dimensional object; and
at least one associated digital destination address; and
saving the registration entry in the database.

14. The method of claim 8, further comprising:
upon determining that the plurality of images contain a detected text string target in the database, determining whether the plurality of images also contain an excluded text string target associated with the detected text string target; and
returning the associated digital destination address only in response to a determination that the excluded text string target is absent in the plurality of images.

15. A computer-readable storage medium having encoded thereon instructions to cause one or more processors to execute a method of quickly connecting a user's computing device to a digital destination, the method comprising:
receiving an image from the user's computing device;
automatically searching, in a database including a plurality of entries each having a text string target and an associated digital destination address, wherein automatically searching comprises:
processing the image;
determining whether the image contains one of the text string targets in the plurality of entries; and
providing the associated digital destination address in response to a determination that the image contains one of the text string targets in the plurality of entries; and
automatically enabling the user's computing device to connect with the digital destination associated digital destination address.

16. The computer-readable storage medium of claim 15, wherein the instructions cause the one or more processors to further execute: receiving an image from the user's computing device comprises receiving an image of a subject selected from the group consisting of a text string, a trademark, a logo, a design, and a 3-dimensional object.

17. The computer-readable storage medium of claim 15, wherein the instructions cause the one or more processors to further execute:
recognizing that the image contains a text string including alphanumeric characters;
removing blank spaces, symbols, and punctuation marks from the text string; and
generating a search text string to be used for searching the database.

18. The computer-readable storage medium of claim 15, wherein the instructions causes the one or more processors to further execute: returning an address pointing to a digital destination selected from the group consisting of a web page, a social media profile, a multimedia channel, a podcast, a playlist, and a metaverse location.

19. The computer-readable storage medium of claim 15, wherein the instructions cause the one or more processors to further execute:
receiving a registration entry comprising:
the target selected from the group consisting of a text string, a trademark, at least one image file depicting a logo, at least one image file depicting a design, and at least one image file depicting a 3-dimensional object; and
at least one associated digital destination address; and
saving the registration entry in the database.

20. The computer-readable storage medium of claim 15, wherein the instructions cause the one or more processors to further execute: upon determining that the image contains the text string target in an entry, determine whether the image contains an excluded text string target, and returning the associated digital destination address in response to a determination that the excluded text string target is absent in the image.
